(19) United States
(12) Patent Application Publication
(10) Pub. No.: US 2013/0033487 A1
(43) Pub. Date: Feb. 7, 2013

(54) IMAGE TRANSFORMING DEVICE AND METHOD

(71) Applicants: Seung-ryong HAN, Suwon-si (KR); Jong-sul MIN, Suwon-si (KR); Sung-jin KIM, Suwon-si (KR); Jin-sung LEE, Suwon-si (KR)

(72) Inventors: Seung-ryong HAN, Suwon-si (KR); Jong-sul MIN, Suwon-si (KR); Sung-jin KIM, Suwon-si (KR); Jin-sung LEE, Suwon-si (KR)

(73) Assignee: SAMSUNG ELECTRONICS CO., LTD., Suwon-si (KR)

(21) Appl. No.: 13/442,492

(22) Filed: Apr. 9, 2012

(30) Foreign Application Priority Data
Aug. 4, 2011 (KR) 2011-0077786

(51) Int. Cl. G06K 9/46; G06T 15/00; G09G 5/00; G06K 9/00

(52) U.S. Cl. 345/419; 382/154

(57) ABSTRACT

Provided are image transforming device and method. The image transforming method includes: receiving a selection of first and second images which are separately captured; extracting a matching point between the first and second images; calculating a first transformation parameter of the first image and a second transformation parameter of the second image by using the matching point; and applying the first transformation parameter to the first image to generate a left eye image and the second transformation parameter to the second image to generate a right eye image. Therefore, a 3-dimensional (3D) image is generated by using a separately captured image.

### CROSS-REFERENCE TO RELATED APPLICATION

This application claims priority from Korean Patent Application No. 10-2011-0077786, filed on Aug. 4, 2011, in the Korean Intellectual Property Office, the disclosure of which is hereby incorporated herein by reference in its entirety.

### BACKGROUND

1. Field

Apparatuses consistent with exemplary embodiments relate to an image transforming device and method, and more particularly, to an image transforming device and a method for transforming a plurality of images to generate a 3-dimensional (3D) image.

2. Description of the Related Art

Various types of electronic devices have been developed with the development of electronic technology. In particular, a general display apparatus used in a household supports a 3-dimensional (3D) display function due to the advancement of 3D display technology.

Examples of such a display apparatus include a television (TV), a personal computer (PC) monitor, a notebook PC, a mobile phone, a personal digital assistant (PDA), an electronic frame, an electronic book, etc. Therefore, 3D content which may be processed by a 3D display apparatus are supported from various types of sources.

In order to produce 3D content, a plurality of cameras capture an image of an object. In other words, two or more cameras are disposed at a similar angle to a binocular disparity of a human to capture images of same object in order to respectively generate left and right eye images. Therefore, a 3D display apparatus repeatedly outputs the left and right eye images alternately or according to a preset pattern, so that a user feels a 3D effect.

The number and types of 3D display apparatuses have increased. However, since a process of producing 3D content is more complicated than a process of producing general content, it is difficult to secure many and/or various 3D content that the user expects.

Therefore, the user may feel a desire to directly produce 3D content. However, since a general user has a general digital camera, it is not easy for the user to directly produce 3D content.

Accordingly, a technique for producing 3D content by using an image produced by a general camera is required.

### SUMMARY

One or more exemplary embodiments may overcome the above disadvantages and other disadvantages not described above. However, it is understood that one or more exemplary embodiments are not required to overcome the disadvantages described above, and may not overcome any of the problems described above.

One or more exemplary embodiments provide an image transforming device and method for selecting a plurality of images to generate 3-dimensional (3D) content.

According to an aspect of an exemplary embodiment, there is provided an image transforming method. The image transforming method may include: receiving a selection of first and second images which are separately captured; extracting a matching point between the first and second images; calculating a first transformation parameter of the first image and a second transformation parameter of the second image by using the matching point; and applying the first transformation parameter to the first image to generate a left eye image and the second transformation parameter to the second image to generate a right eye image.

Before extracting the matching point, the image transforming method may further include compensating for a color difference and a luminance difference between the first and second images.

The image transforming method may further include: calculating a disparity distribution of matching points between the left and right eye images; calculating a pixel shift amount so that a maximum disparity on the disparity distribution is within a safety guideline; and shifting pixels of each of the left and right eye images according to the calculated pixel shift amount.

The first and second transformation parameters may be a transformation parameter matrix and an inverse matrix, respectively, which are estimated by using coordinates of a matching point between the first and second images.

The image transforming method may further include: cropping the left and right eye images; and overlapping the cropped left and right eye images to display a 3-dimensional (3D) image.

The image transforming method may further include: cropping the left and right images; overlapping the cropped left and right images to generate a 3D image; and transmitting the 3D image to an external device.

According to an aspect of another exemplary embodiment, there is provided an image transforming device. The image transforming device may include: an input unit which receives a selection of first and second images which are separately captured; a matching unit which extracts a matching point between the first and second images; and an image processor which calculates a first transformation parameter of the first image and a second transformation parameter of the second image by using the matching point, applies the first transformation parameter to the first image to generate a left eye image, and applies the second transformation parameter to the second image to generate a right eye image.

The image transforming device may further include a compensator which compensates for a color difference and a luminance difference between the first and second images.

The image transforming device may further include: a storage unit which stores information about a safety guideline; an calculation unit which calculates a disparity distribution from a matching point between the left and right eye images and calculates a pixel shift amount by using the safety guideline, the disparity distribution, and an input image resolution; and a pixel processor which shifts pixels of each of the left and right eye images so that a disparity between the left and right eye images generated by the image processor is within a range of the safety guideline.

The image processor may include: a parameter calculator which estimates a transformation parameter matrix by using coordinates of the matching point between the first and second images and respectively calculates the estimated transformation parameter matrix and an inverse matrix as the first and second transformation parameters; and a transformer which applies the first transformation parameter to the first image to generate the left eye image and applies the second transformation parameter to the second image to generate the right eye image.

The image transforming device may further include a display unit. The image processor may further include a 3D image generator which crops sand overlaps the left and right eye images processed by the pixel processor to generate a 3D image and provides the 3D image to the display unit.

The image transforming device may further include an interface unit which is connected to an external device. The image processor may further include a 3D image generator which crops and overlaps the left and right eye images processed by the pixel processor to generate a 3D image and transmits the 3D image to the external device through the interface unit.

According to an aspect of another exemplary embodiment, there is provided a recording medium storing a program executing an image transforming method. The image transforming method may include: displaying a plurality of pre-stored images; if first and second images are selected from the plurality of pre-stored images, extracting a matching point between the first and second images; calculating a first transformation parameter of the first image and a second transformation parameter of the second image by using the matching point; applying the first transformation parameter to the first image to generate a left eye image and a second transformation parameter to the second image to generate a right eye image; and overlapping the left and right eye images to display a 3D image.

Before extracting the matching point, the image transforming method may further include compensating for a color difference and a luminance difference between the first and second images.

The image transforming method may further include: calculating a disparity distribution of matching points between the left and right eye images; calculating a pixel shift amount so that a maximum disparity on the disparity distribution is within a safety guideline; and shifting the matching points between the left and right eye images according to the calculated pixel shift amount.

As described above, according to the exemplary embodiments, if a user selects a plurality of images, 3D content may be produced by using the selected images.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIGS. 1 through 3 are block diagrams illustrating a configuration of image transforming devices according to various exemplary embodiments;

FIGS. 4 through 8 are views illustrating a process of respectively selecting and processing a plurality of images to generate a 3-dimensional (3D) image according to an exemplary embodiment; and

FIGS. 9 and 10 are flowcharts illustrating image transforming methods according to various exemplary embodiments.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

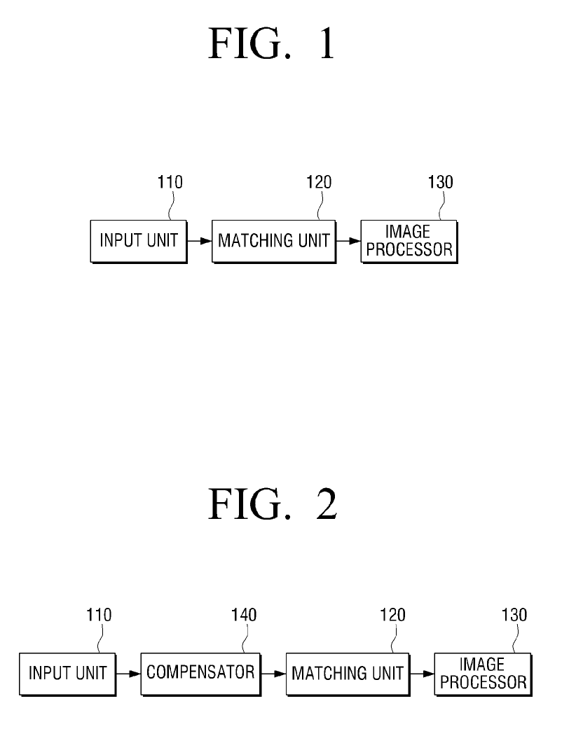

FIG. 1 is a block diagram illustrating a structure of an image transforming device according to an exemplary embodiment. Referring to FIG. 1, the image transforming device includes an input unit 110, a matching unit 120, and an image processor 130.

The input unit 110 receives various user commands or selections. In more detail, the input unit 110 may be realized as various types of input means such as a keyboard, a mouse, a remote controller, a touch screen, a joystick, etc. Alternatively, the input unit 110 may be realized as an input receiving means which receives a signal from these input means and processes the signal. A user may select a plurality of images, which are to be transformed to generate a 3-dimensional (3D) image, through the input unit 110. Images which are to be selected may be read from a storage unit (not shown) of the image transforming device or an external storage means or may be provided from a device such as a camera or a server connected to the image transforming device. The user may select two images which look similar to each other in the eyes of the user.

At least two images of same object may be captured at different angles to form and overlap to generate a 3D image. Therefore, the user may select at least two or more images. Hereinafter, images selected by the user will be referred to as first and second images. In other words, the input unit 110 receives selections of first and second images.

The matching unit 120 extracts a matching point between the selected first and second images. The matching point refers to a point at which first and second images match with each other.

The matching unit 120 checks pixel values of pixels of the first and second images to detect points having pixel values belonging to a preset range or having the same pixel value. In this case, the matching unit 120 does not compare the pixels on a one-to-one basis but detects the matching point in consideration of neighboring pixels. In other words, if a plurality of pixels having the same or similar pixel values consecutively appear in the same patterns at an area, the matching unit 120 may detect the area or a pixel within the area as the matching point.

In more detail, the matching unit 120 may detect the matching point by using a Speeded Up Robust Features (SURF) technique, an expanded SURF technique, a Scale Invariant Feature Transform (SIFT) technique, or the like. These techniques are well known in the art, and thus their detailed descriptions will be omitted herein.

The image processor 130 respectively calculates a first transformation parameter for the first image and a second transformation parameter for the second image by using the matching point.

The image processor 130 may calculate the first and second transformation parameters by using coordinate values of each of matching points detected by the matching unit 120. In other words, the image processor 130 may calculate the first and second transformation parameters by using Equation 1 below.

$$[ \begin{matrix}{x}^{l} \\ {y}^{l} \\ l\end{matrix} ] = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}{x}^{r} \\ {y}^{r} \\ l\end{matrix} ] \qquad ( 1 )$$

If each coordinate of a matching point of the first image and each coordinate of a matching point of the second image are substituted with (x¹, y¹) and (x^{r}, y^{r}) in Equation 1, m₁₁ through m₃₃ may be calculated. A transformation parameter matrix including m₁₁ through m₃₃ may be determined as a first transformation parameter, and an inverse matrix may be determined as a second transformation parameter. According to another exemplary embodiment, an inverse matrix may be determined as a first transformation parameter, and the transformation parameter matrix may be determined as a second transformation parameter.

The image processor 130 transforms each of the pixels of the first image by using the first transformation parameter to calculate a new pixel coordinate value. Therefore, the image processor 130 may generate a left eye image constituted by calculated pixel coordinate values. The image processor 130 may also calculate a new pixel coordinate value by using the second transformation parameter of the second image to generate a right eye image.

The first and second images are separately captured and generated. Therefore, although the same object is captured to generate the first and second images, a position, a shape, and a size of the object vary depending on a capturing position, a distance from the object, a capturing angle, a position of lighting, and so on. In other words, a geometric distortion exists between two images. The image processor 130 respectively transforms the first and second images by respectively using the first and second transformation parameters to compensate for the geometric distortion. Therefore, the first and second images rotate, and the size of the object increases or decreases, so that the first and second images are respectively transformed into the left and right eye images.

As described above, the first image is transformed into the left eye image, and the second image is transformed into the right eye image, but their transformation orders are not necessarily limited thereto. In other words, the first image may be transformed into a right eye image, and the second image may be transformed into a left eye image.

The image processor 130 respectively crops the generated left and right eye images and overlaps the left and right eye images to generate a 3D image.

FIG. 2 is a block diagram illustrating a structure of an image transforming device according to another exemplary embodiment. Referring to FIG. 2, the image transforming device includes an input unit 110, a matching unit 120, an image processor 130, and a compensator 140.

The compensator 140 compensates for color differences and luminance differences among a plurality of images selected by a user. If a 3D image is generated by using a plurality of images, a photometric distortion may occur due to a color or luminance difference between two images, thereby increasing a degree of watching fatigue.

The compensator 140 compensates for luminances and colors of first and second images to match histograms of the first and second images with each other. In more detail, the compensator 140 may calculate the histograms based on one of the two images. Therefore, the compensator 140 compensates for the luminance and color of the other image to adjust the histogram of the other image in order to match the histogram of the other image with the histogram of the based image.

In order to compensate for a luminance and a color, the compensator 140 extracts a luminance value Y and chromaticity values Cr and Cb by using image information of an image which is to be compensated for. If the image information includes red (R), green (G), and blue (B) signals, the compensator 140 extracts the luminance value Y and the chromaticity values Cr and Cb through a color coordinate transformation process as in Equation 2 below.

Y=0.299R+0.587G+0.114B

Cb=−0.169R−0.331G+0.5B (2)

Cr=0.51R−0.419G−0.081B

The compensator 140 adjusts the luminance value Y and the chromaticity values Cb and Cr according to a luminance curve and a gamma curve to match with the histogram of a reference image. The compensator 140 calculates R, G, and B values by using the adjusted luminance value Y and chromaticity values Cb and Cr and reconstitutes the image by using the calculated R, G, and B values. Therefore, the compensator 140 compensates for luminance and color differences between the first and second images.

The matching unit 120 detects a matching point by using the compensated first and second images. Differently from the exemplary embodiment of FIG. 1, the matching unit 120 detects the matching point after color and luminance differences are compensated. Therefore, detection accuracy may further increase.

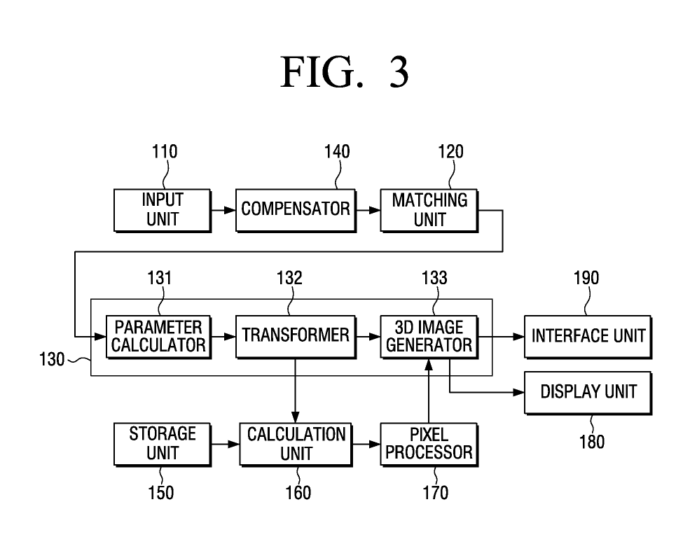

FIG. 3 is a block diagram illustrating a structure of an image transforming device according to another exemplary embodiment.

Referring to FIG. 3, the image transforming device includes an input unit 110, a matching unit 120, an image processor 130, a compensator 140, a storage unit 150, a calculation unit 160, a pixel processor 170, a display unit 180, and an interface unit 190. The image processor 130 includes a parameter calculator 131, a transformer 132, and a 3D image generator 133.

The parameter calculator 131 of the image processor 130 estimates a transformation parameter matrix by using coordinates of matching points of first and second images and calculates the estimated transformation parameter matrix and an inverse matrix as first and second transformation parameters, respectively. In more detail, the parameter calculator 131 substitutes coordinate values of matching points of the first and second images for Equation 1 above to calculate a plurality of equations and calculates values m₁₁ through m₃₃ of the equations to calculate the transformation parameter matrix and the inverse matrix. Equation 1 above is formed of 3×3 matrix but is not necessarily limited thereto. Therefore, Equation 1 may be formed of n×m (where n and m are arbitrary natural numbers) matrix.

The transformer 132 applies the first transformation parameter calculated by the parameter calculator 131 to the first image to generate a left eye image and applies the second transformation parameter to the second image to generate a right eye image.

The storage unit 150 stores information about a safety guideline. The safety guideline includes a disparity, a frequency, a watching distance, etc. which are set so that a user does not feel dizziness or fatigue when watching a 3D image for a long time.

The calculation unit 160 calculates a disparity distribution from the matching point detected by the matching unit 120. In other words, the calculation unit 160 detects a maximum value and a minimum value of a disparity between matching points of the left and right eye images. The calculation unit 160 determines whether the detected maximum value of the disparity satisfies the disparity set in the safety guideline. If it is determined that the detected maximum value of the disparity satisfies the disparity set in the safety guideline, the calculation unit 160 determines a pixel shift amount as 0. In other words, the calculation unit 160 generates a 3D image by using the left and right eye images generated by the image processor 130 without an additional adjustment of a pixel position.

If it is determined that the detected maximum value of the disparity does not satisfy the disparity set in the safety guideline, the calculation unit 160 determines a pixel shift amount so that the maximum value of the disparity is within a range of the safety guideline. In this case, the calculation unit 160 may consider a resolution of an input image and a resolution of an output device. In other words, a unit of pixel shift for adjusting a disparity may vary according to various input/output image resolutions such as Video Graphics Array (VGA), eXtended Graphics Array (XGA), full high definition (FHD), 4K, etc. In more detail, in order to adjust the same disparity, in the case of an image having a high resolution, a relatively large number of pixels are to be shifted. In the case of an image having a low resolution, a relatively small number of pixels are to be shifted. The calculation unit 160 may calculate a pixel shift amount in consideration of a unit of pixel shift corresponding to an input/output image resolution ratio.

Also, the calculation unit 160 may nonlinearly determine the pixel shift amount according to a size of the disparity so that a left and right inverse phenomenon does not occur in a part having a minimum disparity. In other words, the calculation unit 160 may set a pixel shift amount to a large value with respect to a part having a large disparity and to a relatively low value or 0 with respect to a part having a small disparity.

The pixel shift amount calculated by the calculation unit 160 is provided to the pixel processor 170.

The pixel processor 170 shifts pixels of at least one of the left and right eye images according to the pixel shift amount provided from the calculation unit 160, so that a disparity between the left and right eye images generated by the image processor 130 is within the range of the safety guideline. Pixel-shifted images are provided to the 3D image generator 133.

The 3D image generator 133 crops the left and right eye images processed by the image processor 170 to sizes, which correspond to each other, to generate a 3D image. Here, the 3D image may be a 3D image file which is generated by overlapping the cropped left and right eye images or a file which respectively stores the cropped left and right eye images.

The display unit 180 displays the 3D image by using data output from the 3D image generator 133. In other words, if the 3D image generator 133 overlaps the cropped left and right eye images to generate a 3D image, the display unit 180 may immediately display the 3D image. Alternatively, if the 3D image generator 133 separately outputs the cropped left and right eye images, the display unit 180 may overlap the output left and right eye images to output the overlapped images in a 3D image format.

The interface unit 190 transmits data output from the 3D image generator 133 to an external device.

The display of the 3D image or the transmission of the 3D image to the external device may be selectively performed according to a selection of a user.

The image transforming devices of FIGS. 1 through 3 may be realized as image processing devices such as TVs, PCs, or set-top boxes or as single chips, modules, or devices which are installed in or connected to the image processing devices.

Both of the display unit 180 and the interface unit 190 may be installed or only one of the display unit 180 and the interface unit 190 may be installed. In other words, if the image transforming device is realized as a PC, a 3D image may be displayed directly through a monitor connected to the PC or may be transmitted to a device such as an external server. If the image transforming device is realized as a set-top box, the image transforming device may include only the interface unit 190 which transmits a 3D image to an external device such as a TV connected to the set-top box.

In the exemplary embodiments of FIGS. 1 through 3, the image transforming device may display a user interface (UI) window, which includes a thumbnail image or related texts of each image, so that a user easily selects an image. In other words, if a user command to transform an image is input through the input unit 110, the image transforming device detects images, which are stored in the storage unit 150, a storage medium connected to the image transforming device, and an external device, and displays a UI window including the images on a screen. In this case, thumbnail images, titles, related texts, selection areas, etc. of the images may be additionally displayed in the UI window. The user may check a selection area to directly select a plurality of images.

Alternatively, if the user inputs a user command to transform an image, the image transforming device may compare available images to automatically select a plurality of images which somewhat match with one another. In other words, as described above, according to various exemplary embodiments, in order to achieve an image transformation, a matching point is to exist between selected two images. Therefore, if the user selects two different images, an image transformation is not normally performed. Therefore, if the user selects a menu for an image transformation, the image transforming device may compare a plurality of pre-stored images to automatically select images among which the predetermined number or more of matching points exist or may display only the images in a UI window to induce the user to select the images. This operation may be performed by an additional element which is not shown in FIGS. 1 through 3, e.g., a controller, but is not necessarily limited thereto. Therefore, this operation may be programmed to be automatically performed by the matching unit 120.

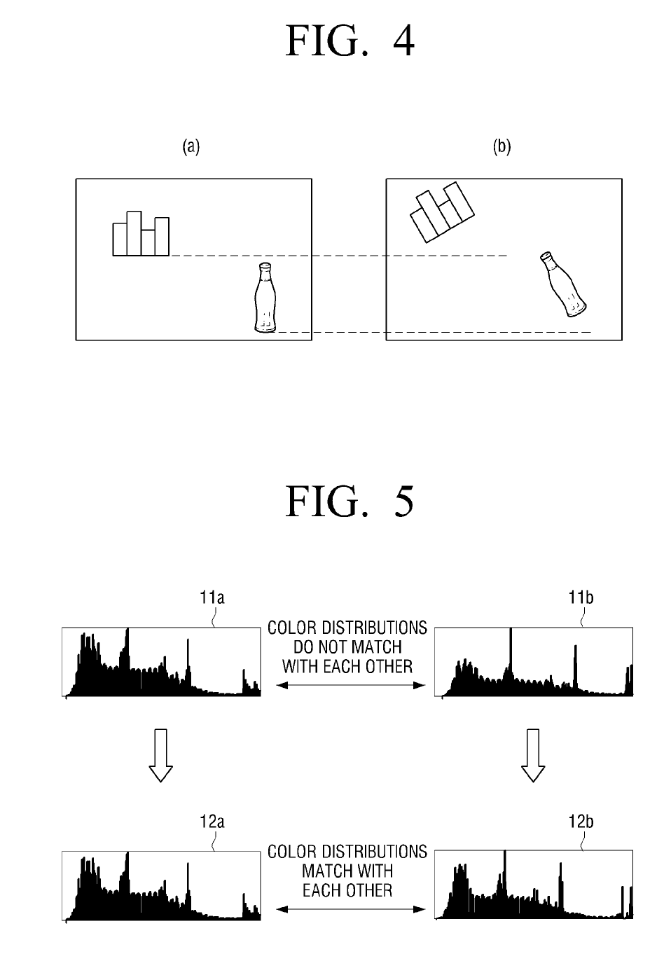

FIG. 4 is a view illustrating a first image (a) and a second image (b) selected by an image transforming device, according to an exemplary embodiment. As shown in FIG. 4, a user selects two images of the same objects. However, since the two images are respectively captured by a monocular camera, positions, shapes, and display angles of the objects in the images are different from one other. The user may input a file name or directly select thumbnail images to respectively select the first and second images.

FIG. 5 is a view illustrating a process of compensating for colors of first and second images according to an exemplary embodiment. As shown in FIG. 5, when a histogram 11a of the first image (a) is compared with a histogram 11b of the second image (b), a color distribution of the first image (a) does not match with a color distribution of the second image (b).

Therefore, based on one of the first and second images (a) and (b), a color of the other one may be adjusted to match the histograms 11a and 11b of the first and second images (a) and (b) with each other. Alternatively, colors of the first and second images (a) and (b) may be respectively adjusted to match the histograms 11a and 11b of the first and second images (a) and (b) with each other.

If the colors are adjusted, a histogram 12a of the first image (a), not completely but somewhat similarly matches with a histogram 12b of the second image (b). Color histograms are shown in FIG. 5, but luminance may be adjusted together with the colors.

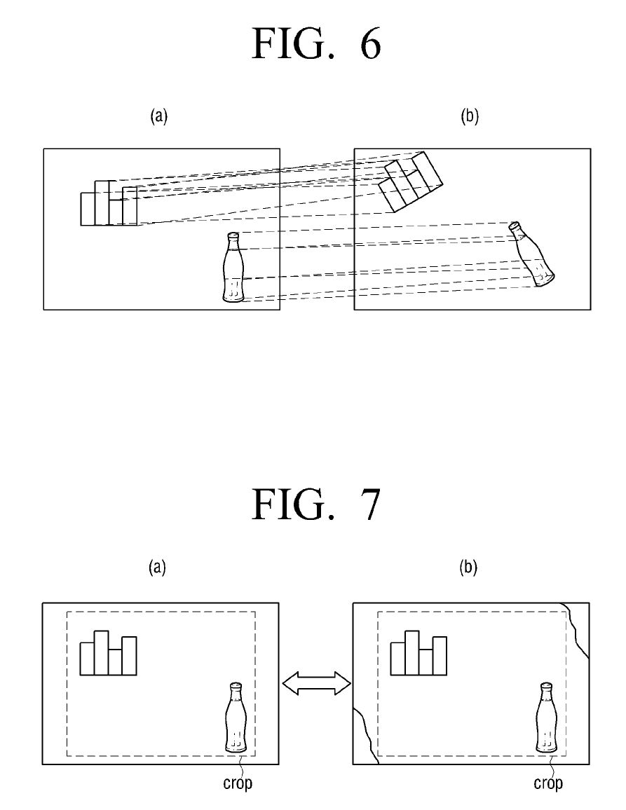

FIG. 6 is a view illustrating a process of detecting a matching point between first and second images (a) and (b) after a color and a luminance of the first images (a) matches with a color and a luminance of the second images (b), according to an exemplary embodiment. As described above, in order to detect a matching point, various techniques, such as SURF, extended SURF, and SIFT techniques, may be used. As shown in FIG. 6, a plurality of matching points exist between the first and second images (a) and (b).

An image transforming device generates first and second transformation parameters by using the matching points and respectively transforms the first and second images a and b by using the first and second transformation parameters.

FIG. 7 is a view illustrating a transformed first image, i.e., a left eye image (a), and a transformed second image, i.e., a right eye image (b), according to an exemplary embodiment. Referring to FIG. 7, the left and right eye images (a) and (b) are respectively transformed to change positions, shapes, display angles, etc. of objects in the left and right eye images (a) and (b) into a similar range. In other words, the left and right eye images (a) and (b) are respectively rotated in one direction, and sizes of the objects are adjusted, so that a predetermined area in the left eye image (a) and a predetermined area in the right eye image (b) match with each other. Therefore, matching areas of the left and right eye images (a) and (b) are cropped. Before cropping the matching areas of the left and right eye images (a) and (b), a process of shifting pixels of at least one of the left and right eye images (a) and (b) according to safety guideline information may be performed so that a user does not feel dizziness or watching fatigue.

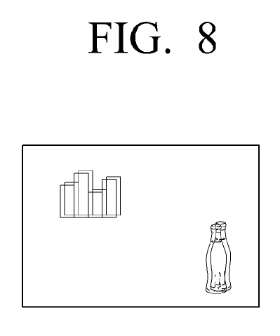

FIG. 8 is a view illustrating a 3D image which is generated by overlapping cropped left and right eye images, according to an exemplary embodiment. As shown in FIG. 8, the generated 3D image may be displayed or stored in an image transforming device or may be transmitted to an external device.

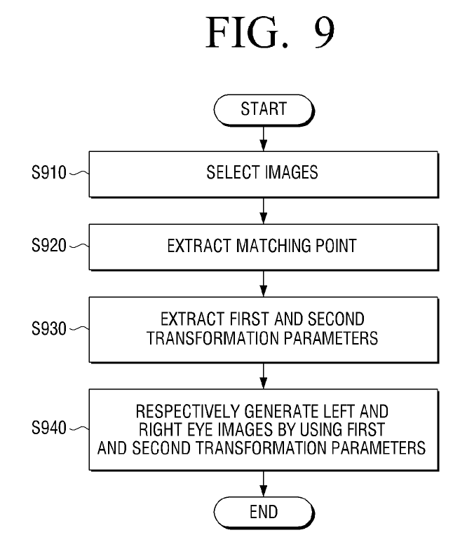

FIG. 9 is a flowchart illustrating an image transforming method according to an exemplary embodiment. Referring to FIG. 9, in operation S910, first and second images are selected by a user. In operation S920, a matching point between the selected first and second images is extracted.

In operation S930, first and second transformation parameters are calculated by using the matching point. In operation S940, the first transformation parameter is applied to the first image to generate a left eye image, and the second transformation parameter is applied to the second image to generate a right eye image.

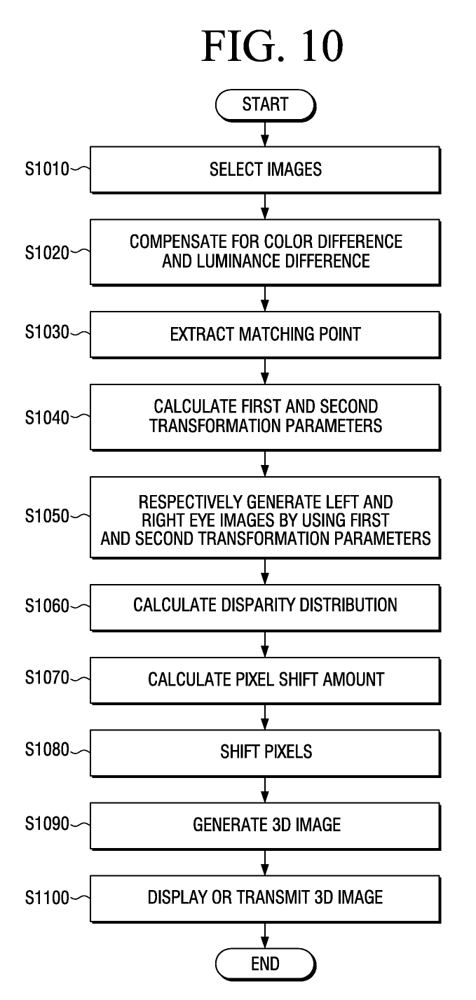

FIG. 10 is a flowchart illustrating an image transforming method according to another exemplary embodiment. Referring to FIG. 10, in operation S1010, first and second images are selected. In operation S1020, color and luminance differences between the selected first and second images are compensated for. Here, only the color and luminance differences are specified, but other image characteristics may be compensated for to match with one another.

In operation S1030, a matching point between the first and second images having the compensated color and luminance differences is extracted. In operation S1040, first and second transformation parameters are calculated by using the calculated matching point.

In operation S1050, left and right eye images are respectively generated by using the calculated first and second transformation parameters.

In operation S1060, a disparity distribution between pixels of the generated left and right eye images is calculated. In operation S1070, a pixel shift amount is calculated by using the calculated disparity distribution. As described above, the pixel shift amount is determined based on a safety guideline. In operation S1080, pixels are shifted according to the pixel shift amount. Therefore, a pixel having a disparity exceeding the safety guideline is shifted.

In operation S1090, finally generated left and right eye images are synthesized to generate a 3D image. In operation S1100, the generated 3D image is displayed or transmitted to an external device. As a result, a user may generate a 3D image by using a plurality of images which are separately captured by using a monocular camera.

An image transforming method according to the above-described various exemplary embodiments may be executed by a program which is stored in various types of recording medium to be executed by central processing units (CPUs) of various types of electronic devices.

In more detail, a program for executing the above-described methods may be stored in various types of computer readable recording medium such as a random access memory (RAM), a flash memory, a read only memory (ROM), an erasable programmable ROM (EPROM), an electronically erasable and programmable ROM (EEPROM), a register, a hard disk, a removable disk, a memory card, a universal serial bus (USB) memory, a compact disk (CD)-ROM, etc.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image transforming method comprising:
receiving a selection of first and second images which are separately captured;
extracting a matching point between the first and second images;
calculating a first transformation parameter for the first image and a second transformation parameter for the second image by using the matching point; and
applying the first transformation parameter to the first image to generate a left eye image and the second transformation parameter to the second image to generate a right eye image.

2. The image transforming method as claimed in claim 1, before extracting the matching point, further comprising compensating for a color difference and a luminance difference between the first and second images.

3. The image transforming method as claimed in claim 2, further comprising:
calculating a disparity distribution of matching points between the left and right eye images;
calculating a pixel shift amount so that a maximum disparity on the disparity distribution is within a safety guideline; and
shifting pixels of each of the left and right eye images according to the calculated pixel shift amount.

4. The image transforming method as claimed in claim 3, wherein the first and second transformation parameters are a transformation parameter matrix and an inverse matrix, respectively, which are estimated by using coordinates of a matching point between the first and second images.

5. The image transforming method as claimed in claim 3, further comprising:
cropping the left and right eye images; and
overlapping the cropped left and right eye images to display a 3-dimensional (3D) image.

6. The image transforming method as claimed in claim 3, further comprising:
cropping the left and right images;
overlapping the cropped left and right images to generate a 3D image; and
transmitting the 3D image to an external device.

7. An image transforming device comprising:
an input unit which receives a selection of first and second images which are separately captured;
a matching unit which extracts a matching point between the first and second images; and
an image processor which calculates a first transformation parameter for the first image and a second transformation parameter for the second image by using the matching point, applies the first transformation parameter to the first image to generate a left eye image, and applies the second transformation parameter to the second image to generate a right eye image.

8. The image transforming device as claimed in claim 7, further comprising a compensator which compensates for a color difference and a luminance difference between the first and second images.

9. The image transforming device as claimed in claim 8, further comprising:
a storage unit which stores information about a safety guideline;
a calculation unit which calculates a disparity distribution from a matching point between the left and right eye images and calculating a pixel shift amount by using the safety guideline, the disparity distribution, and an input image resolution; and
a pixel processor which shifts pixels of each of the left and right eye images so that a disparity between the left and right eye images generated by the image processor is within a range of the safety guideline.

10. The image transforming device as claimed in claim 9, wherein the image processor comprises:
a parameter calculator which estimates a transformation parameter matrix by using coordinates of the matching point between the first and second images and respectively calculates the estimated transformation parameter matrix and an inverse matrix as the first and second transformation parameters; and
a transformer which applies the first transformation parameter to the first image to generate the left eye image and applies the second transformation parameter to the second image to generate the right eye image.

11. The image transforming device as claimed in claim 10, further comprising a display unit,
wherein the image processor further comprises a 3D image generator which crops and overlaps the left and right eye images processed by the pixel processor to generate a 3D image and provides the 3D image to the display unit.

12. The image transforming device as claimed in claim 10, further comprising an interface unit which is connected to an external device,
wherein the image processor further comprises a 3D image generator which crops and overlaps the left and right eye images processed by the pixel processor to generate a 3D image and transmits the 3D image to the external device through the interface unit.

13. A recording medium storing a program executing an image transforming method,
wherein the image transforming method comprises:
displaying a plurality of pre-stored images;
if first and second images are selected from the plurality of pre-stored images, extracting a matching point between the first and second images;
calculating a first transformation parameter for the first image and a second transformation parameter for the second image by using the matching point;
applying the first transformation parameter to the first image to generate a left eye image and a second transformation parameter to the second image to generate a right eye image; and
overlapping the left and right eye images to display a 3D image.

14. The recording medium as claimed in claim 13, wherein before extracting the matching point, the image transforming method further comprises compensating for a color difference and a luminance difference between the first and second images.

15. The recording medium as claimed in claim 14, wherein the image transforming method further comprises:
calculating a disparity distribution of matching points between the left and right eye images;
calculating a pixel shift amount so that a maximum disparity on the disparity distribution is within a safety guideline; and
shifting the matching points between the left and right eye images according to the calculated pixel shift amount.

16. An image transforming method comprising:
extracting a matching point between a first and second image;
calculating a first transformation parameter for the first image and a second transformation parameter for the second image by using the matching point; and
applying the first transformation parameter to the first image to generate a left eye image and the second transformation parameter to the second image to generate a right eye image.
